(19) United States
(12) Patent Application Publication
(10) Pub. No.: US 2009/0143255 A1
(43) Pub. Date: Jun. 4, 2009

(54) Methods and Compositions for Improving Well Bore Stability in Subterranean Formations

(76) Inventors: Gary P. Funkhouser, Duncan, OK (US); Lewis Rhyne Norman, Duncan, OK (US); Brian P. Grady, Norman, OK (US)

Correspondence Address: CRAIG W. RODDY;HALLIBURTON ENERGY SERVICES, P.O. BOX 1431, DUNCAN, OK, 73536-0440, US

(21) Appl. No.: 11/948,358

(22) Filed: Nov. 30, 2007

(51) Int. Cl. C09K 8/035

(52) U.S. Cl. 507/121

(57) ABSTRACT

Films that may be created and/or placed in a well bore that prevent the flow of fluid into cracks or fractures in a portion of a subterranean formation penetrated by the well bore, and associated methods of use, are provided. In one embodiment, the methods comprise: providing a treatment fluid that comprises a base fluid and a film-forming polymer; introducing the treatment fluid into a portion of a well bore penetrating a portion of a subterranean formation, the well bore comprising an interior wall; and allowing the film-forming polymer to electrostatically interact with a surface of the interior wall of the well bore to form a substantially continuous film along a portion of the interior wall of the well bore, the substantially continuous film being capable of hindering the flow of a fluid therethrough.

### BACKGROUND

The present invention relates to methods and compositions useful in subterranean operations, and more specifically, to films that may be created and/or placed in a well bore that prevent the flow of fluid into cracks or fractures in a portion of a subterranean formation penetrated by the well bore, and associated methods of use.

Many subterranean operations involve the drilling of a well bore from the surface through rock and/or soil to penetrate a subterranean formation containing fluids that are desirable for production. Such drilling operations may include any suitable technique for forming a well bore that penetrates a subterranean formation. Rotary drilling operations typically involve attaching a drill bit on a lower end of a drillstring to form a drilling tool and rotating the drill bit along with the drillstring into a subterranean formation to create a well bore through which subsurface formation fluids may be produced. In another method of drilling, coiled tubing may be used instead of jointed pipe. During drilling, a drilling fluid may be used, inter alia, to lift or circulate formation cuttings out of the well bore to the surface, to cool the drill bit, and/or to power downhole motors used in the drilling process.

In some cases, after a well bore has been drilled to a desired depth, the drillstring may be removed from the well bore, and a variety of completion and stimulation operations, including but not limited to cementing, fracturing treatments, sand control treatments, remedial treatments, and the like may be performed before the desired fluids are produced through the bore hole and out of the well. These operations may involve the use of one or more treatment fluids. As used herein, the term “treatment fluid” refers to any fluid that may be used in an application in conjunction with a desired function and/or for a desired purpose. The term “treatment” does not imply any particular action by the fluid or any component thereof. In certain operations (e.g., drilling operations), it may be desirable to introduce and/or maintain the treatment fluids into the well bore at certain levels of hydraulic pressure in the well bore.

In the course of drilling such a well bore, the interior walls of the bore hole may become cracked or fractured due to, among other things, stresses occurring naturally in the subterranean formation and/or stresses generated in the course of performing the drilling operation or some other subsequent operation. Among other things, these cracks and fractures may allow portions treatment fluids subsequently placed in the well bore to leak off into the subterranean formation, cause a loss of hydraulic pressure in the well bore, and/or otherwise jeopardize the stability of the well bore.

To help mitigate these problems, several different types of treatments have been employed. For example, water-soluble polymers and other substances (e.g., silicates) may be pumped into the subterranean formation in an effort to attempt to reduce the matrix permeability of sands and rock in the formation matrix to fluids, or to form a filter cake to slow the diffusion of water into the formation matrix. However, in order for these treatments to be effective, certain conditions in the subterranean formation (such as temperature, pressure, rock type, rock surface chemistry, etc.) may be necessary, among other things, to place, precipitate, and/or activate these substances within the formation. Unless these conditions are maintained relatively precisely, such treatments may be ineffective or unreliable. However, creating and/or maintaining these conditions may require complicated pre-treatments, or in some cases, may not be possible in certain subterranean formations due to, for example, naturally-occurring phenomena and/or the performance of other operations in that formation. Also, in some cases, isolation techniques may be required to place these substances in a portion of the subterranean formation where treatment is needed, which may add cost and/or complexity to the operations. Finally, such treatments do not necessarily prevent the bulk flow of fluid into the formation, and thus may not prevent the formation and/or enlargement of fractures or cracks in the walls of the well bore or lost circulation into those fractures or cracks.

### SUMMARY

The present invention relates to methods and compositions useful in subterranean operations, and more specifically, to films that may be created and/or placed in a well bore that prevent the flow of fluid into cracks or fractures in a portion of a subterranean formation penetrated by the well bore, and associated methods of use.

In one embodiment, the present invention provides methods comprising: providing a treatment fluid that comprises a base fluid and a film-forming polymer; introducing the treatment fluid into a portion of a well bore penetrating a portion of a subterranean formation, the well bore comprising an interior wall; and allowing the film-forming polymer to electrostatically interact with a surface of the interior wall of the well bore to form a substantially continuous film along a portion of the interior wall of the well bore, the substantially continuous film being capable of hindering the flow of a fluid therethrough.

In another embodiment, the present invention provides methods of drilling a well bore comprising: providing a drilling fluid; using the drilling fluid to drill at least a portion of a well bore penetrating a portion of a subterranean formation; providing a treatment fluid that comprises a base fluid and a film-forming polymer; introducing the treatment fluid into a portion of a well bore penetrating a portion of a subterranean formation, the well bore comprising an interior wall; and allowing the film-forming polymer to electrostatically interact with a surface of the interior wall of the well bore to form a substantially continuous film along a portion of the interior wall of the well bore, the substantially continuous firm being capable of hindering the flow of a fluid therethrough.

In another embodiment, the present invention provides methods of treating a portion of a well bore penetrating a subterranean formation wherein a first film resides along a surface of a portion of an interior wall of the well bore, the methods comprising: providing a treatment fluid that comprises a base fluid and a film-forming polymer; introducing the treatment fluid into the portion of the well bore; allowing the film-forming polymer to electrostatically interact with a portion of the first film and/or the surface of the interior wall of the well bore to form a substantially continuous film along a portion of the interior wall of the well bore.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to methods and compositions useful in subterranean operations, and more specifically, to films that may be created and/or placed in a well bore that prevent the flow of fluid into cracks or fractures in a portion of a subterranean formation penetrated by the well bore, and associated methods of use.

The methods of the present invention generally comprise: providing a treatment fluid that comprises a base fluid and a film-forming polymer; introducing the treatment fluid into a portion of a well bore penetrating a portion of a subterranean formation, the well bore comprising an interior wall; and allowing the film-forming polymer to electrostatically interact with a surface in the well bore (e.g., the surface of the interior wall of the well bore) to form a substantially continuous film along a portion of the interior wall of the well bore that is capable of hindering or preventing the flow of fluid through the film. As used herein, the term “treatment fluid” refers to any fluid that may be used in an application in conjunction with a desired function and/or for a desired purpose. The term “treatment” does not imply any particular action by the fluid or any component thereof. The “electrostatic interactions” (and derivatives of that term) referred to herein are defined to include interactions occurring as a result of the respective electrostatic potentials of (1) the surface of the particles of the film-forming polymer and (2) the surface with which they interact. These electrostatic interactions may result in, among other results, the adsorption of polymer particles onto the surface with which they interact.

The term “film-forming polymer” refers to any polymeric material that is capable of forming a substantially continuous film on a surface via electrostatic interactions between (1) the film-forming polymer (e.g., particles of the film-forming polymer) and (2) the surface in the well bore. The term “substantially continuous film” refers to any substantially continuous layer and does not require any particular thickness or degree of uniformity in the film over any particular length. The term “substantially continuous” is defined herein to mean that, to the extent that the film is placed along a portion of the interior wall of the well bore that has a fracture or crack therein, the film should be sufficiently continuous to hinder or prevent the bulk flow of fluid therethrough. However, notwithstanding this definition, the term “substantially continuous” does not otherwise require that the film cover any other particular length along the interior wall in the well bore, or be of any particular composition or thickness along any given length. Moreover, the terms “fracture” and “crack”, as used herein, do not require that such fractures and cracks be of any particular size. Rather, such cracks and fractures may be of any size, and may include, but are not limited to microcracks, microfractures, and cracks and fractures not visible to the naked eye. The interior wall of the well bore in the methods of the present invention may be run along the entire length of the well bore, or it may only run along some portion of the well bore.

The methods of the present invention may be used before, during, or following any subterranean operation wherein a well bore penetrating a subterranean formation is present or created. These subterranean operations may include, but are not limited to, preflush treatments, afterflush treatments, drilling operations, hydraulic fracturing treatments, sand control treatments (e.g., gravel packing), acidizing treatments (e.g., matrix acidizing or fracture acidizing), “frac-pack” treatments, well bore clean-out treatments, and the like. For example, the methods of the present invention may be used to form a substantially continuous film along a portion of the interior wall of a well bore where it is desirable to prevent lost fluid circulation that may result from, for example, fractures or cracks in the interior walls of the well bore that occur naturally or were created or enlarged during some prior operation (e.g., the drilling of the well bore). In certain embodiments, the methods of the present invention may be used prior to, in conjunction with, or during the same operation that creates the fractures or cracks in the interior walls of the well bore, for example, during the drilling of the well bore.

Among the many benefits of the present invention, these methods may provide a treatment that effectively prevents the bulk flow of fluid through the interior walls of the well bore. This may, among other things, reduce the formation and/or enlargement of fractures or cracks in the interior walls of the well bore at a given pressure, reduce lost fluid circulation, and/or inhibit shale swelling or degradation in the subterranean formation. Even where the methods of the present invention do not prevent the formation or enlargement of fractures or cracks in the interior walls of the well bore, these methods may prevent the flow of fluid into those fractures or cracks, which still may reduce fluid loss, and/or inhibit shale swelling or degradation in the subterranean formation. Certain methods of the present invention provide, among other things, methods of treatment that involve treating at the surface of the interior walls of a well bore, and do not necessarily require the placement of any substances within the formation matrix.

The film-forming polymers used in the methods of the present invention may comprise any polymer that is capable of forming a substantially continuous film on a surface via electrostatic interactions between the film-forming polymer and the surface in the well bore. The film-forming polymers used in the methods of the present invention may be prepared in a form that is dispersible in a fluid. In particular applications of the present invention, the film-forming polymer should be capable of forming a film in the operating conditions and surroundings found in that application, although that same film-forming polymer may not be capable of forming a film under other operating conditions or in the presence of other surroundings and substances. For example, in certain embodiments where aqueous fluids may be introduced into the well bore after the formation of the film, it may be desirable to choose a film-forming polymer(s) that does not substantially dissolve into water or any other aqueous fluid that may be brought into contact with it without additional treatment or modification of the film-forming polymer(s). However, in certain embodiments, water-soluble polymers also may be used as the film-forming polymer(s). Likewise, a film-forming polymer used in a particular embodiment of the present invention may form a film while in contact with or surrounded by aqueous fluids, while that polymer may or may not form a film under “dry” conditions.

Examples of polymers that the film-forming polymers of the present invention may comprise include, but are not limited to acrylates, urethanes, sulfones, polyolefins, vinyl chlorides (e.g., polyvinyl chloride (PVC)), vinylidene chlorides (e.g., polyvinylidene chloride (PVDC)), styrenics, amides, ethers, and derivatives thereof. The term “derivative” includes any compound that is made from one of the listed compounds, for example, by replacing one atom in the listed compound with another atom or group of atoms, rearranging two or more atoms in the listed compound, ionizing one of the listed compounds, or creating a salt of one of the listed compounds. The term “derivative” also includes copolymers, terpolymers, and oligomers of the listed compound. In certain embodiments, the molecules of the film-forming polymer may comprise one or more acid or amine groups thereon. In certain embodiments, the film-forming polymers may comprise polymers formed in a latex emulsion, which, in some cases, may comprise acid groups thereon. Such emulsion latex polymers may be formed using a “core-shell” type polymerization, among other purposes, to concentrate acid or amine groups on the outside of the polymer molecules.

A person of ordinary skill, with the benefit of this disclosure, will be able to choose a film-forming polymer suitable for use in the present invention. Factors that may be considered in choosing a film-forming polymer for a particular application of the present invention include, but are not limited to the ease of dispersing the polymer, the particular surfactant(s) used to form the dispersion, the properties of the fluid in which the polymer is to be dispersed (e.g., composition, pH, etc.), the electrostatic potential (i.e., the charge) of the polymer or particles comprising the polymer, the electrostatic potential of the surface in the well bore, the size of polymer molecules, the size of the polymer particles, the degradation temperature of the polymer, the properties of the film that the polymer will form (e.g., tensile strength, thickness, elongation, etc.), conditions within the well bore (e.g., temperature), and the like.

The film-forming polymer may be present in the treatment fluid used in the methods of the present invention in any amount needed to form the substantially continuous film in the desired region in the well bore, up to the maximum amount that may be sufficiently dispersed in the base fluid. In certain embodiments, the film-forming polymer may be present in an amount in the range of from about 0.1% to about 66% by volume of the treatment fluid. A person of skill in the art, with the benefit of this disclosure, will recognize the appropriate amount of the film-forming polymer to include in the treatment fluid for a particular application of the present invention.

The base fluids used in the treatment fluids of the present invention may comprise any fluid that does not adversely interact with the other components used in accordance with this invention and/or with the subterranean formation. For example, the base fluid may comprise an aqueous-based fluid, an organic fluid (e.g., alcohols and/or glycols), a hydrocarbon-based fluid (e.g., kerosene, xylene, toluene, diesel, oils, etc.), a foamed fluid (e.g., a liquid that comprises a gas), and/or a gas (e.g., nitrogen or carbon dioxide). Aqueous-based fluids may comprise fresh water, salt water, brine, or seawater, or any other aqueous fluid that does not adversely react with the other components used in accordance with this invention or with the subterranean formation.

The base fluid optionally may comprise any other additives known in the art, including, but not limited to, salts, surfactants, fluid loss control additives, surface modifying agents, foamers, additional corrosion inhibitors, catalysts, clay control agents, biocides, friction reducers, antifoam agents, bridging agents, dispersants, flocculants, H₂S scavengers, CO₂ scavengers, oxygen scavengers, lubricants, viscosifiers, breakers, weighting agents, resins, particulate materials, wetting agents, coating enhancement agents, electrolytes, and the like. A person of skill in the art, with the benefit of this disclosure, will recognize if any such additives are appropriate for a particular application of the present invention.

Generally, the film-forming polymer should be dispersed in the base fluid to form the treatment fluid. In certain embodiments, it may be necessary to treat the film-forming polymer and/or the base fluid with additional additives to form and/or maintain such a dispersion. For example, one or more dispersants or surfactants may be used to disperse the film-forming polymer in the base fluid. Examples of surfactants that may be added to perform this function include, but are not limited to methyl ester sulfonates, hydrolyzed keratin, sulfosuccinates, taurates, amine oxides, ethoxylated amides, alkoxylated fatty acids, alkoxylated alcohols, ethoxylated fatty amines, ethoxylated alkyl amines, betaines, modified betaines, alkylamidobetaines, quaternary ammonium compounds, alkyl sulfates, alkylbenzenesulfonates, polymeric surfactants (e.g., polymeric surfactants carrying the HYPERMER™ tradename, available from Uniqema, New Castle, Del.), and any derivatives thereof. A person of skill in the art, with the benefit of this disclosure, will recognize the type and amount of surfactant that is appropriate for a particular application of the present invention based on, among other things, the type and/or amount of film-forming polymer used.

In certain embodiments, the film-forming polymer and/or other components of the treatment fluid may be formulated such that the substantially continuous film will form along the interior wall of the well bore without any further steps or actions. In other embodiments, it may be necessary or desirable to perform additional steps or actions before, while, or after the treatment fluid comprising the film-forming polymer is introduced into the well bore to form the substantially continuous film.

For example, in certain embodiments, it may be desirable to introduce a preflush fluid into the well bore before the treatment fluid comprising the film-forming polymer is introduced into the well bore, among other purposes, to remove undesirable substances from the well bore and/or to create a surface charge on the surface in the well bore. The formation of the surface charge may, among other things, facilitate the formation of the film along the interior walls of the well bore. Such preflush fluids may comprise any fluid known in the art such as aqueous-based fluids, hydrocarbon-based fluids (e.g., kerosene, xylene, toluene, diesel, oils, etc.), foamed fluids (e.g., a liquid that comprises a gas), and/or gases (e.g., nitrogen or carbon dioxide). Aqueous-based preflush fluids may comprise fresh water, salt water, brine, or seawater, or any other aqueous fluid. In those embodiments where a preflush fluid comprising saltwater or a brine is used, the saltwater or brine may comprise any salt known in the art, including, but not limited to divalent and/or trivalent salts. The optional preflush fluids may comprise any other additional additives known in the art, including but not limited to surfactants, acids, bases, fluid loss control additives, surface modifying agents, foamers, additional corrosion inhibitors, catalysts, clay control agents, biocides, friction reducers, antifoam agents, bridging agents, dispersants, flocculants, H₂S scavengers, CO₂ scavengers, oxygen scavengers, lubricants, viscosifiers, breakers, weighting agents, resins, particulate materials (e.g., calcium carbonate), pH adjusting agents, wetting agents, coating enhancement agents, electrolytes (or polyelectrolytes) and the like. Moreover, the pH of the preflush fluid may be adjusted, among other things, to optimize the surface charge created on the interior walls of the well bore.

However, in certain embodiments of the present invention, such preflushes may not be necessary depending on, among other things, the natural or pre-existing conditions (e.g., the surface charge) of the surface in the well bore where the substantially continuous film is to be formed. A person of ordinary skill in the art, with the benefit of this disclosure, will recognize when a preflush fluid may be desirable or necessary for a particular application of the present invention, and if used, what the composition of that preflush fluid should have.

After the treatment fluid comprising the film-forming polymer is introduced into the well bore, the substantially continuous film should be allowed to form. In certain embodiments, the film may be formed by drying the portions of the film-forming polymer that have come into contact the interior wall of the well bore.

The methods of the present invention may be used to form a substantially continuous film along the interior walls of an entire well bore, or any portion or interval thereof. For example, the methods of the present invention may be used as a “spot treatment,” wherein the treatment fluid comprising the film-forming polymer is introduced into only a portion of the well bore (e.g., a particular interval along the length of the well bore). This may be accomplished by any means known in the art for performing such a spot treatment, including hydrajetting systems, coiled tubing apparatuses, pulsonic systems (e.g., systems capable of applying a pressure pulse having a given amplitude and frequency to a fluid), the existing drill string, and the like. In certain embodiments, a particular interval of the well bore to be treated may be isolated from other portions of the well bore using a variety of methods and/or equipment, including but not limited to diverting agents, gels, plugs, packers, and the like.

In certain embodiments, the methods of the present invention optionally may comprise the additional step of introducing one or more afterflush fluids into the portion of the well bore where the substantially continuous film has been formed. These afterflush fluids may be used, among other purposes, to displace excess amounts of the film-forming polymer in the well bore, modify or enhance the mechanical and/or chemical properties of the film, prepare the well bore for further operations or treatments, or the like. Such afterflush fluids may comprise any fluid known in the art such as aqueous-based fluids, hydrocarbon-based fluids (e.g., kerosene, xylene, toluene, diesel, oils, etc.), foamed fluids (e.g., a liquid that comprises a gas), and/or gases (e.g., nitrogen or carbon dioxide). Aqueous-based afterflush fluids may comprise fresh water, salt water, brine, or seawater, or any other aqueous fluid. In those embodiments where an afterflush fluid comprising saltwater or a brine is used, the saltwater or brine may comprise any salt known in the art, including, but not limited to divalent and/or trivalent salts. The optional afterflush fluids may comprise any other additional additives known in the art, including but not limited to surfactants, acids, fluid loss control additives, surface modifying agents, foamers, additional corrosion inhibitors, catalysts, clay control agents, biocides, friction reducers, antifoam agents, bridging agents, dispersants, flocculants, H₂S scavengers, CO₂ scavengers, oxygen scavengers, lubricants, viscosifiers, breakers, weighting agents, resins, particulate materials (e.g., calcium carbonate), pH adjusting agents, wetting agents, coating enhancement agents, electrolytes (or polyelectrolytes) and the like. Moreover, the pH of the afterflush fluid may be adjusted, among other things, to optimize the surface charge created on the interior walls of the well bore and/or to help remove water from the film formed in the methods of the present invention.

The methods of the present invention may be used to treat a well bore wherein a first film resides along the surface of the interior wall in the portion of the well bore to be treated, for example, prior to performing a method of the present invention. This first film may comprise, among other things, a substantially continuous film. The pre-existing film may be naturally-occurring, may have been placed using a method of the present invention, and/or may have been placed using some other method known in the art. In these embodiments, the methods of the present invention may comprise: providing a treatment fluid that comprises a base fluid and a film-forming polymer; introducing the treatment fluid into the portion of the well bore; allowing the film-forming polymer to electrostatically interact with a portion of the first film and/or the surface of the interior wall of the well bore to form a substantially continuous film along the surface of the interior wall of the well bore. In certain embodiments, the particles of the film-forming polymer(s) in the second treatment fluid may carry a charge that is the opposite of the charge on the first film already present on the surface of the interior wall of the well bore. The charge on the first film may be due to the inherent charge of the polymer particles comprising the film, and/or may have been altered with one or more preflush or afterflush fluids, such as those described in paragraphs [0024], [0025] and [0028]. Among other purposes, the second substantially continuous film may be formed at any time after the first film has been formed, among other purposes, to form a composite polymer film of desired thickness, composition, strength, surface charge, and/or uniformity, and/or to cover portions of the surface of the interior wall of the well bore that were not covered by the first film.

In certain embodiments, the methods of the present invention used to form a first substantially continuous film along a surface of an interior wall in a well bore optionally may comprise the additional steps of, after the first substantially continuous film is formed: introducing a second treatment fluid comprising one or more film-forming polymers into the portion of the well bore wherein at least a portion of the first substantially continuous film was formed along the surface of the interior wall of the well bore; and allowing the film-forming polymers in the second treatment fluid to electrostatically interact with a portion of the first substantially continuous film and/or the surface of the interior wall of the well bore to form a second substantially continuous film along the surface of the interior wall of the well bore. The film-forming polymer(s) in the second treatment fluid may comprise the same film-forming polymer(s) used to form the first substantially continuous firm, or they may comprise one or more different film-forming polymers.

In certain embodiments, the methods of the present invention optionally may comprise the step of removing at least a portion of the substantially continuous film formed along the interior wall of the well bore. For example, it may be desirable to remove at least a portion of the substantially continuous film where it may adversely affect a subsequent operation (e.g., a cementing operation), or where it becomes desirable to allow a fluid to flow into one or more cracks or fractures in the interior walls of the well bore. Where it is desirable to remove a portion of the substantially continuous film in the well bore, this may be accomplished by any means known in the art. For example, a fluid in which the film-forming polymer is soluble may be introduced into the well bore, thereby dissolving at least a portion of the substantially continuous film. In other embodiments, a fluid comprising an acid may be introduced into the well bore, wherein the acid may be formulated or chosen to dissolve or break down at least a portion of the substantially continuous film. In other embodiments, the electrostatic attractions between the polymer particles and the surface on the interior wall of the well bore may be reduced, which may cause at least a portion of the substantially continuous film to detach from the surface.

To facilitate a better understanding of the present invention, the following example of certain aspects of some embodiments are given. In no way should the following example be read to limit, or define, the entire scope of the invention.

### EXAMPLE

A portion of a subterranean well bore was simulated in the laboratory by placing two 6-inch lengths of 0.5-inch steel pipe placed end-to-end opposite each other with the ends approximately 2 inches apart, and a metal cylinder with a tight PVC braided tubing over it was inserted through both pipes to keep the 2-inch gap open while a cement block is formed around the facing ends of the pipes. The cement slurry was comprised of the following materials: 22% HYDROMITE™ (a gypsum cement and plastic resin composition); 57% HYDROSTONE® (a gypsum cement composition); 1.2% CFR-3™, a cement friction reducer available from Halliburton Energy Services, Duncan, Okla.; 20.5% water; and 0.3% Catalyst A™, a catalyst compatible with the resin component of HYDROMITE™ available from Halliburton Energy Services, Duncan, Okla. The slurry then was poured into a mold surrounding the facing ends of the steel pipes to form a block and permitted to set. The cement block was soaked with CaCl₂ overnight and then allowed to dry. The cement block formed was approximately 9 inches in height (along axis of the pipes), 6 inches in width, and 6 inches in length. The two pipes communicated with each other through the gap in the block between the pipes, and any remaining spaces between the outer surfaces of the pipes and the cement were sealed.

Simulated well bores were created according to this procedure for each run of each sample tested. For each test run, the exposed end of one of the pipes was capped, and hydraulic pressure was applied to the other pipe using a Ruskam positive-displacement pump. One sample was tested as a control sample with no substance placed in the simulated well bore (Sample No. 1), and another sample was tested with a plastic fruit bag (thickness 8 microns) (Sample No. 2) placed in the gap between the pipes in the simulated well bore. For Sample Nos. 1 and 2, water was flushed through the simulated well bore at a rate of about 50 mL/min for 10 minutes. Each of the other ten samples was tested by flushing an aqueous solution having the compositions listed in Table 1 below through each simulated well bore at a rate of about 50 mL/min for 10 minutes. During each test run, the simulated well bore was maintained at room temperature. In each test run, a total solution volume of 3-5 L was used, and after pumping, the solution was recycled into the mix jar. The pressure at which the cement block cracked during each test run was recorded, and the average cracking pressure of all test runs for each sample is reported in Table 1 below.

TABLE 1

| | | Average cracking | Adjusted average |
|---|---|---|---|
| | Composition of | pressure | cracking pressure¹ |
| Sample No. | Sample Solution | (number of runs) | (number of runs) |
| 1 | Water (control - no coating) | 1000 ± 50 psi (1) | 1000 ± 50 psi (1) |
| 2 | Water (coating = 8-micron fruit | 1300 ± 90 psi (5) | 1300 ± 90 psi (5) |
| | bags) | | |
| 3 | Poly(acrylic acid) | 1000 ± 70 psi (10) | 1000 ± 70 psi (10) |
| | (MW ≈ 3,000,000 g/mol)² | | |
| 4 | Poly(acrylamide)³ | 1000 ± 30 psi (4) | 1000 ± 30 psi (4) |
| 5 | Poly(styrene-sulfonic acid) | 1100 ± 50 psi (5) | 1120 ± 35 psi (4) |
| | (MW ≈ 70,000 g/mol)⁴ | | |
| 6 | Poly(acrylamide-coacrylic acid) | 1110 ± 40 psi (5) | 1110 ± 40 psi (5) |
| | (10% acid, 90% sodium salt; | | |
| | MW ≈ 200,000 g/mol)⁵ | | |
| 7* | 0.05 MF methacrylic acid; | 1090 ± 95 psi (11) | 1090 ± 95 psi (11) |
| | 0.45 MF butyl acrylate; | | |
| | 0.5 MF methyl methacrylate | | |
| 8* | 0.612 MF butyl acrylate; | 1150 ± 100 psi (11) | 1200 ± 75 psi (7) |
| | 0.388 MF methyl methacrylate | | |
| 9* | 0.05 MF methacrylic acid; | 1150 ± 20 psi (5) | 1150 ± 20 psi (5) |
| | 0.636 MF butyl acrylate; | | |
| | 0.314 MF methyl methacrylate | | |
| 10* | 0.05 MF methacrylic acid; | 1070 ± 45 psi (8) | 1090 ± 20 psi (6) |
| | 0.37 MF butyl acrylate; | | |
| | 0.58 MF methyl methacrylate | | |
| 11* | 0.1 MF methacrylic acid; | 1010 ± 65 psi (8) | 1010 ± 65 psi (8) |
| | 0.66 MF butyl acrylate; | | |
| | 0.24 MF methyl methacrylate | | |
| 12* | 0.05 MF methacrylic acid; | 1160 ± 40 psi (5) | 1160 ± 40 psi (5) |
| | 0.566 MF butyl acrylate; | | |
| | 0.384 MF methyl methacrylate | | |

*The polymers in Samples 7-12 were used in 5% aqueous solutions. The polymers were made using an emulsion core-shell approach, in which the core was made of the last two monomers listed while the shell was made with all three monomers. The amount of monomer used in the core was approximately 20% of the total monomer. The surfactant used in the polymerization process was sodium dodecyl sulfate (SDS).
¹In certain test runs for Sample Nos. 5, 8, and 10, the cracking pressure was equivalent to the cracking pressure for the control sample (Sample No. 1). The “adjusted average cracking pressure” for each of these samples excludes the test runs where the cracking pressure was equivalent to that of the control sample. The numbers in parentheses next to each of the average and adjusted average cracking pressures reflect the number of test runs included in each average.
²Used in 0.75%-1% aqueous solution.
³Used in 10% aqueous solution.
⁴Used in 5% aqueous solution.
⁵Used in 1.5% aqueous solution.

Thus, the data above demonstrates that the methods of the present invention may enhance the stability of a well bore penetrating a portion of a subterranean formation and/or minimize the flow of fluid into cracks or fractures created in a well bore penetrating that formation at certain pressures.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Moreover, the indefinite article “a”, as used in the claims, is defined herein to mean to one or more than one of the element that it introduces. Also, the terms in the claims have their plain, ordinary meaning unless otherwise explicitly and clearly defined by the patentee.

What is claimed is:

1. A method comprising:
providing a treatment fluid that comprises a base fluid and a film-forming polymer;
introducing the treatment fluid into a portion of a well bore penetrating a portion of a subterranean formation, the well bore comprising an interior wall; and
allowing the film-forming polymer to electrostatically interact with a surface of the interior wall of the well bore to form a substantially continuous film along a portion of the interior wall of the well bore, the substantially continuous film being capable of hindering the flow of a fluid therethrough.

2. The method of claim 1 wherein the film-forming polymer comprises at least one polymer that is substantially water insoluble.

3. The method of claim 1 wherein the film-forming polymer comprises at least one water-soluble polymer.

4. The method of claim 1 wherein the film-forming polymer is present in a latex.

5. The method of claim 1 wherein the film-forming polymer comprises at least one polymer selected from the group consisting of: an acrylate; an urethane; a sulfone; a polyolefin; a vinyl chloride; a styrenic; an amide; an ether; and any derivative thereof.

6. The method of claim 1 wherein the film-forming polymer is present in the treatment fluid in an amount from about 0.1% to about 66% by volume of the treatment fluid.

7. The method of claim 1 wherein the treatment fluid further comprises one or more surfactants.

8. The method of claim 1 wherein the maximum hydraulic pressure that can be maintained in the well bore is increased after allowing the substantially continuous film to form by at least about 90 psi.

9. The method of claim 1 further comprising introducing a preflush fluid into the portion of the well bore.

10. The method of claim 1 further comprising:
introducing a second treatment fluid comprising a film-forming polymer into the portion of the well bore where at least a portion of the substantially continuous film was formed along the portion of the interior wall of the well bore; and
allowing the film-forming polymer or particles comprising the film-forming polymer in the second treatment fluid to electrostatically interact with a portion of the first substantially continuous film and/or the surface of the interior wall of the well bore to form a second substantially continuous film along a portion of the interior wall of the well bore.

11. The method of claim 1 further comprising removing at least a portion of the film formed along the interior wall of the well bore.

12. A method of drilling a well bore, the method comprising:
providing a drilling fluid;
using the drilling fluid to drill at least a portion of a well bore penetrating a portion of a subterranean formation;
providing a treatment fluid that comprises a base fluid and a film-forming polymer;
introducing the treatment fluid into a portion of a well bore penetrating a portion of a subterranean formation, the well bore comprising an interior wall; and
allowing the film-forming polymer to electrostatically interact with a surface of the interior wall of the well bore to form a substantially continuous film along a portion of the interior wall of the well bore, the substantially continuous firm being capable of hindering the flow of a fluid therethrough.

13. The method of claim 12 wherein the film-forming polymer comprises at least one polymer that is substantially water insoluble.

14. The method of claim 12 wherein the film-forming polymer is present in a latex.

15. The method of claim 12 wherein the film-forming polymer comprises at least one polymer selected from the group consisting of: an acrylate; an urethane; a sulfone; a polyolefin; a vinyl chloride; a styrenic; an amide; an ether; and any derivative thereof.

16. A method of treating a portion of a well bore penetrating a subterranean formation wherein a first film resides along a surface of a portion of an interior wall of the well bore, the method comprising:
providing a treatment fluid that comprises a base fluid and a film-forming polymer;
introducing the treatment fluid into the portion of the well bore;
allowing the film-forming polymer to electrostatically interact with a portion of the first film and/or the surface of the interior wall of the well bore to form a substantially continuous film along a portion of the interior wall of the well bore.

17. The method of claim 16 wherein the first film comprises a substantially continuous film.

18. The method of claim 16 wherein the film-forming polymer is present in a latex.

19. The method of claim 16 wherein the film-forming polymer comprises comprises at least one polymer selected from the group consisting of: an acrylate; an urethane; a sulfone; a polyolefin; a vinyl chloride; a styrenic; an amide; an ether; and any derivative thereof.

20. The method of claim 16 further comprising introducing a preflush fluid into the portion of the well bore.
